(19) United States
(12) Patent Application Publication
(10) Pub. No.: US 2026/0327031 A1
(43) Pub. Date: Oct. 22, 2026

(54) SHEET FEEDING SYSTEM AND SHEET FEEDING METHOD

(71) Applicants: Yasunobu Kidoura, MIYAGI (JP); Kenta Sayama, IWATE (JP)

(72) Inventors: Yasunobu Kidoura, MIYAGI (JP); Kenta Sayama, IWATE (JP)

(73) Assignee: ETRIA Co., Ltd., Kanagawa (JP)

(21) Appl. No.: 19/636,242

(22) Filed: Apr. 1, 2026

(30) Foreign Application Priority Data
Apr. 16, 2025 (JP) 2025-067505

(51) Int. Cl. B65H 7/20; B41J 29/44; B65H 5/26

(52) U.S. Cl. CPC B65H 7/20; B41J 29/44; B65H 5/26; B65H 2801/03

(57) ABSTRACT

A sheet feeding system includes an apparatus body; a first sheet feeder to selectively perform sheet feeding with power from the apparatus body in response to a print instruction from the apparatus body; a second sheet feeder to selectively perform sheet feeding with power from the first sheet feeder in response to the print instruction; a conveyance motor in the first sheet feeder; a first drive path in which the power is supplied to the conveyance motor without passing through the second sheet feeder; a second drive path in which the power is supplied to the conveyance motor via the second sheet feeder; a cutoff circuit to cut off the power supply through the first drive path when an overcurrent occurs in the first sheet feeder; and a switch to switch from the first drive path to the second drive path when the cutoff circuit cuts off the power supply.

### CROSS-REFERENCE TO RELATED APPLICATIONS

This patent application is based on and claims priority pursuant to 35 U.S.C. §119(a) to Japanese Patent Application No. 2025-067505, filed on Apr. 16, 2025, in the Japan Patent Office, the entire disclosure of which is hereby incorporated by reference herein.

### BACKGROUND

### Technical Field

The present disclosure relates to a sheet feeding system and a sheet feeding method.

### RELATED ART

An electronic device equipped with an optional device includes a main body control board that controls a main body of the electronic device, and another control board, such as a peripheral device control board, that controls the optional device. In a proposed technique, the main body control board is connected the peripheral device control board by a cable or a harness, supplies power to the peripheral device control board, and communicates with the peripheral device control board. A method of connecting a plurality of units in series by a cable or a harness in this manner may be generally referred to as daisy-chain connection. In an image forming apparatus having a plurality of sheet feeding units, each of the sheet feeding units may be equipped with the aforementioned peripheral device control board. This allows the sheet feeding units to collaboratively perform a sheet feeding operation.

An example of such a system including a plurality of sheet feeding units is a system including an image forming apparatus, a first sheet feeding device, and a second sheet feeding device. In the system, under the control of a controller of the image forming apparatus, the first sheet feeding device conveys a recording sheet and sends the recording sheet to the image forming apparatus via the second sheet feeding device. A switch of the image forming apparatus simultaneously turns on or off conveying power supplied to the first and second sheet feeding devices to simultaneously start or stop conveying operations of the first and second sheet feeding devices.

### SUMMARY

The present disclosure described herein provides a sheet feeding system including an apparatus body including apparatus circuitry to output a print instruction, a first sheet feeder to selectively perform sheet feeding with power from the apparatus body in response to the print instruction, a second sheet feeder to selectively perform sheet feeding with power from the first sheet feeder in response to the print instruction, and a conveyance motor to generate a sheet feeding force. The conveyance motor is included in the first sheet feeder. The sheet feeding system further includes a first drive path in which the power from the apparatus body is supplied to the conveyance motor without passing through the second sheet feeder, a second drive path in which the power from the apparatus body is supplied to the conveyance motor via the second sheet feeder, a cutoff circuit to cut off the power supply through the first drive path when an overcurrent occurs in the first sheet feeder, and a switch. The switch switches power supply from the apparatus body to the conveyance motor from the first drive path to the second drive path when the power supply through the first drive path is cut off by the cutoff circuit.

The present disclosure described herein provides a sheet feeding method for a sheet feeding system including an apparatus body, a first sheet feeder including a conveyance motor, a second sheet feeder, a first drive path in which power from the apparatus body is supplied to the conveyance motor without passing through the second sheet feeder, and a second drive path in which the power from the apparatus body is supplied to the conveyance motor via the second sheet feeder. The method includes cutting off, with a cutoff circuit, power supply through the first drive path when an overcurrent occurs in the first sheet feeder; and switching the power supply from the apparatus body to the conveyance motor from the first drive path to the second drive when the power supply through the first drive path is cut off by the cutoff circuit.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIGS. 2A, 2B, and 2C are diagrams illustrating a circuit configuration of a main control board and peripheral device control boards of an image forming apparatus;

FIGS. 3A, 3B,and 3C, are diagrams illustrating a circuit configuration of an image forming apparatus in a normal state;

FIGS. 4A, 4B, and 4C, are diagrams illustrating a circuit configuration of an image forming apparatus in which a fuse is blown;

FIGS. 5A and 5B are timing charts each illustrating a communication operation between a main control board and peripheral device control boards of an image forming apparatus;

FIG. 6 is a flowchart illustrating an operation procedure of a main System on a Chip (SoC) of an image forming apparatus;

FIG. 7 is a flowchart illustrating a procedure of a sheet feeding operation of an image forming apparatus;

FIG. 8 is a diagram illustrating a blown fuse notification screen in an image forming apparatus;

FIG. 9 is a diagram illustrating a substitute sheet feeding execution screen in an image forming apparatus;

FIG. 10 is a diagram illustrating an image rotation execution screen in an image forming apparatus;

FIG. 11 is a diagram illustrating a scaling execution screen in an image forming apparatus; and

FIG. 12 is a diagram illustrating an operation stop notification screen in an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, a sheet feeding system and a sheet feeding method according to embodiments of the present disclosure are described below. As used herein, the singular forms "a," "an," and "the" are intended to include the plural forms as well, unless the context clearly indicates otherwise.

### Overall Configuration of Image Forming Apparatus

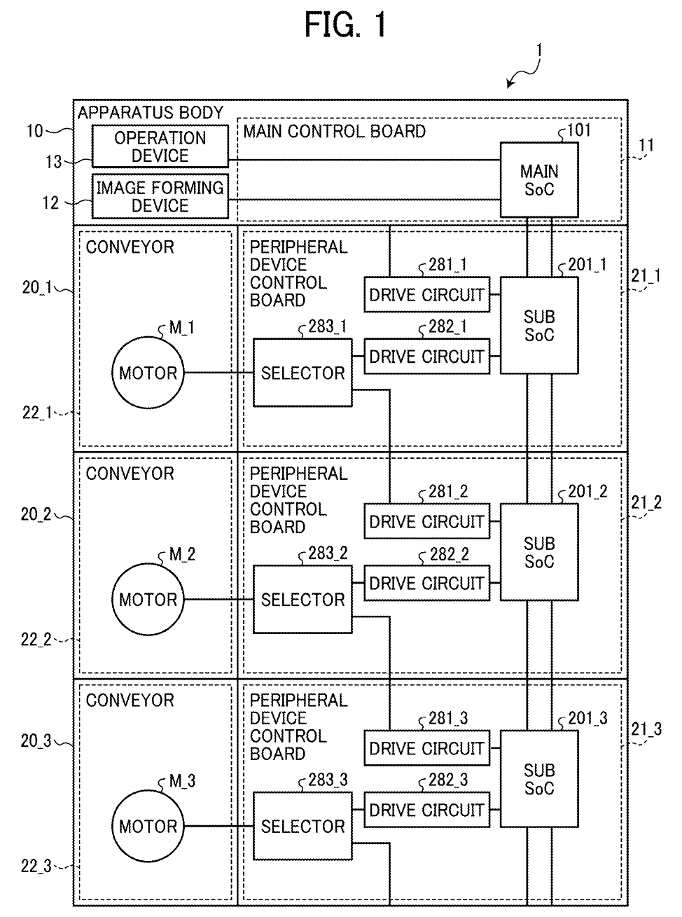

FIG. 1 is a diagram illustrating an overall configuration of an image forming apparatus 1. The overall configuration of the image forming apparatus 1 will be described below with reference to FIG. 1.

The image forming apparatus 1 illustrated in FIG. 1 is an apparatus that forms an image on sheets fed from sheet feeding units arranged in multiple stages. The apparatus that forms an image is an example of a sheet feeding system. As illustrated in FIG. 1, the image forming apparatus 1 includes an apparatus body 10 and sheet feeding units 20_1 to 20_3 (sheet feeders).

The apparatus body 10 includes circuitry that controls operations of the sheet feeding units 20_1 to 20_3, and an image forming device 12 that performs image formation on sheets fed from the sheet feeding units 20_1 to 20_3. As illustrated in FIG. 1, the apparatus body 10 includes a main control board 11, the image forming device 12, and an operation device 13.

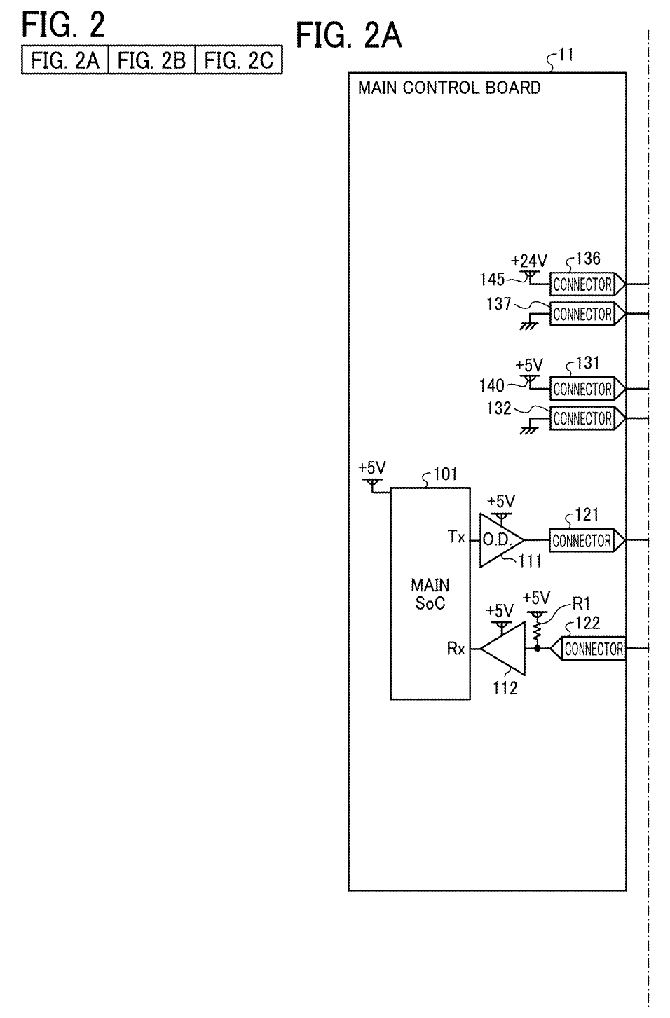

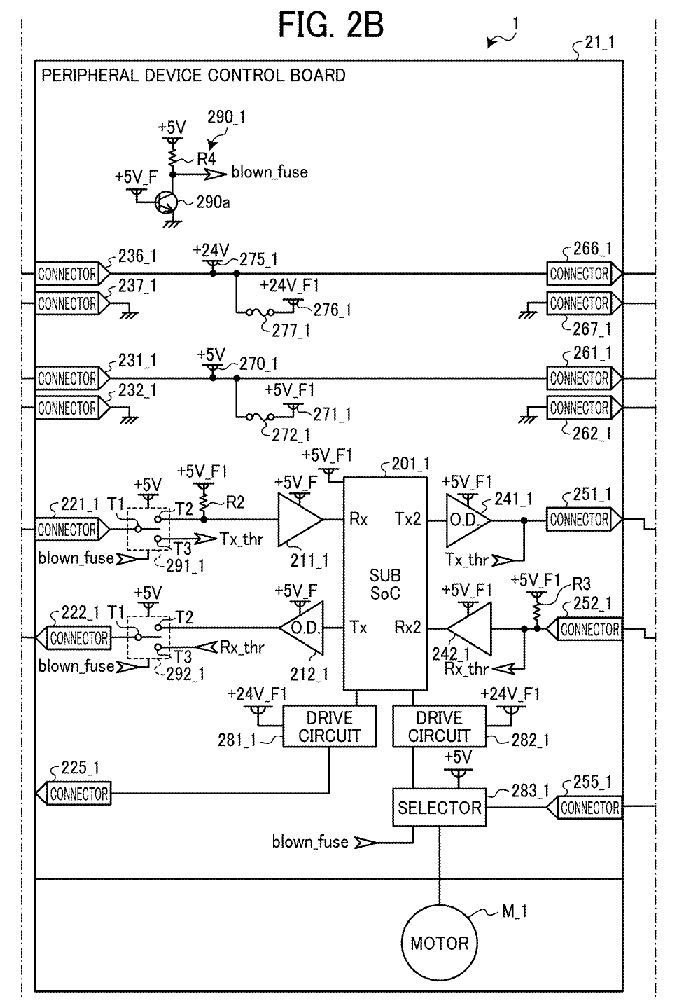

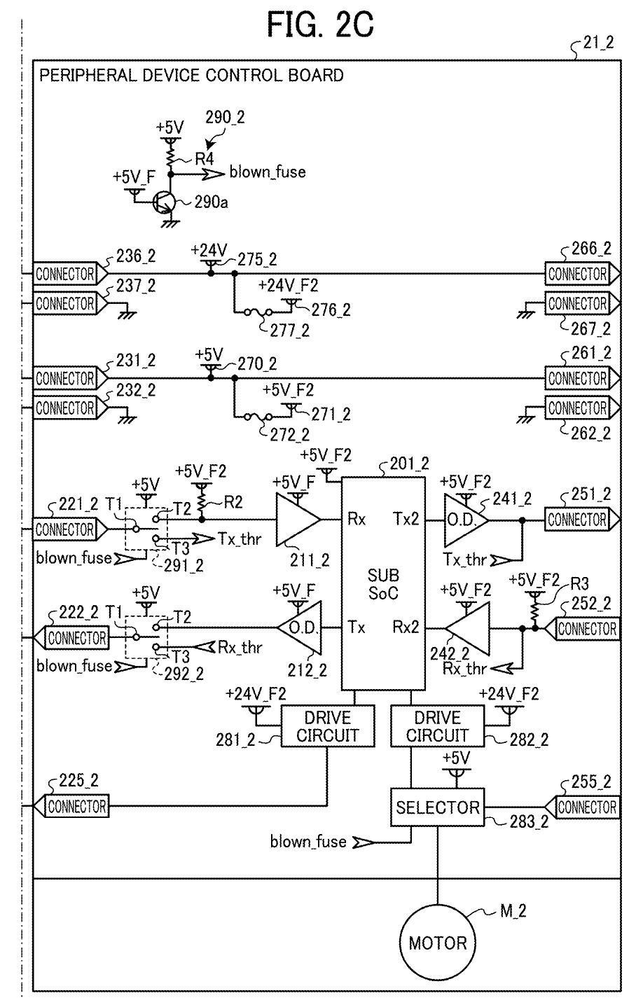

The main control board 11 is a control board that controls the overall operation of the image forming apparatus 1 and is circuitry that generates and outputs a print instruction. The main control board 11 includes a main SoC 101. Functions of the main SoC 101 will be described below with reference to FIG. 2.

The image forming device 12 is an electrophotographic image forming unit that transfers a toner image, developed based on an electrostatic latent image formed on a photoconductor drum, onto a sheet. The image forming device 12 may employ another method such as an inkjet method, instead of the electrophotographic method.

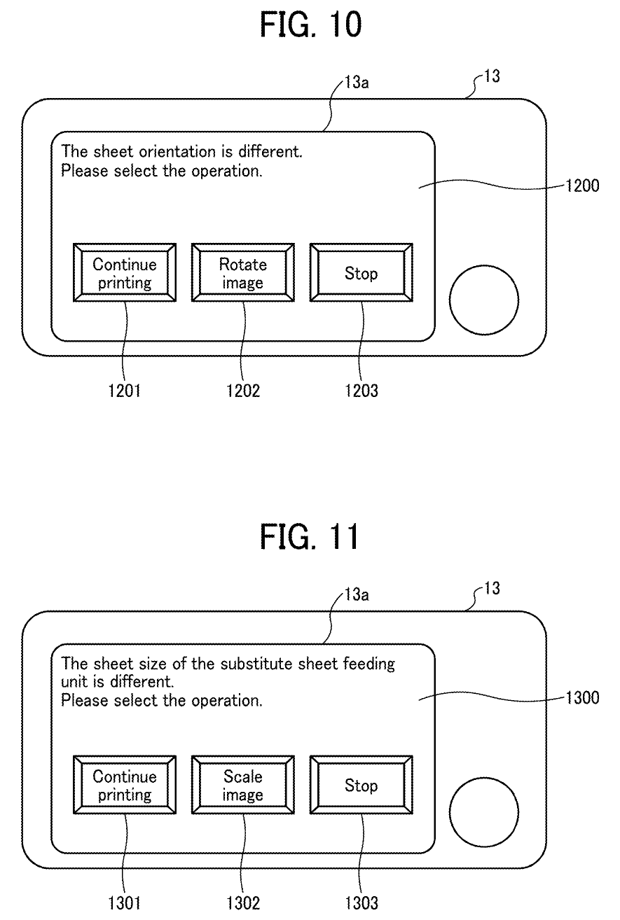

The operation device 13 is an operation display unit for receiving operations on the image forming apparatus 1 and displaying various types of information. As described below, the operation device 13 includes a liquid crystal panel 13a (see FIGS. 10-12) for displaying various types of information. The operation device 13 serves as an "indicator" and an "input device."

The sheet feeding units 20_1 to 20_3 are units in which sheets of different types are loaded and that feed the sheets in accordance with control from the main control board 11. The sheets of different types are, for example, sheets of different materials or sizes. In the example of the configuration of the image forming apparatus 1 illustrated in FIG. 1, the sheet feeding units 20_1, 20_2, and 20_3 are arranged in multiple stages in this order from an upper side toward a lower side. The upper side indicates a position adjacent to the main control board 11.

In the example illustrated in FIG. 1, the image forming apparatus 1 includes three sheet feeding units 20_1 to 20_3. However, the configuration of the image forming apparatus 1 is not limited to this configuration, and the image forming apparatus 1 may include two sheet feeding units or four or more sheet feeding units. When any one of the sheet feeding units is referred to or when the sheet feeding units are collectively referred to, the sheet feeding unit may be referred to simply as a "sheet feeding unit 20". In the example of the image forming apparatus 1 illustrated in FIG. 1, the sheet feeding units 20_1 to 20_3 are arranged in multiple stages in a vertical direction. However, the arrangement is not limited to this arrangement, and the sheet feeding units 20_1 to 20_3 may be arranged in multiple stages in a horizontal direction, for example.

As illustrated in FIG. 1, the sheet feeding unit 20_1 includes a peripheral device control board 21_1 and a conveyor 22_1.

The peripheral device control board 21_1 includes a sub SoC 201_1, a drive circuit 281_1, a drive circuit 282_1, and a selector 283_1. Operations of the sub SoC 201_1, the drive circuit 281_1, the drive circuit 282_1, and the selector 283_1 will be described below with reference to FIG. 2.

The conveyor 22_1 includes a motor M_1 (a driver) for performing a sheet conveying operation.

The sheet feeding units 20_2 and 20_3 have substantially the same configuration as the sheet feeding unit 20_1 described above. Specifically, the sheet feeding unit 20_2 includes a peripheral device control board 21_2 and a conveyor 22_2. The peripheral device control board 21_2 includes a sub SoC 201_2, a drive circuit 281_2, a drive circuit 282_2, and a selector 283_2. The conveyor 22_2 includes a motor M_2 (a driver) for performing a sheet conveying operation.

The sheet feeding unit 20_3 includes a peripheral device control board 21_3 and a conveyor 22_3. The peripheral device control board 21_3 includes a sub SoC 201_3, a drive circuit 281_3, a drive circuit 282_3, and a selector 283_3. The conveyor 22_3 includes a motor M_3 (a driver) for performing a sheet conveying operation.

When any peripheral device control board among the peripheral device control boards 21_1 to 21_3 described above is referred to or when the peripheral device control boards 21_1 to 21_3 described above are collectively referred to, the peripheral device control board may be referred to simply as a "peripheral device control board 21". When any conveyor among the conveyors 22_1 to 22_3 described above is referred to or when the conveyors 22_1 to 22_3 described above are collectively referred to, the conveyor may be referred to simply as a "conveyor 22". When any motor among the motors M_1 to M_3 described above is referred to or when the motors M_1 to M_3 described above are collectively referred to, the motor may be referred to simply as a "motor M".

In the example of the image forming apparatus 1 illustrated in FIG. 1, the peripheral device control boards 21_1, 21_2, and 21_3 are connected in series in this order from the main control board 11 by daisy-chain connection, and mutually perform data communication by a communication method, for example, two-wire serial communication such as universal asynchronous receiver-transmitter (UART). The two-wire serial communication may be referred to simply as serial communication below. The aforementioned communication method is not limited to UART, and may be serial communication such as, for example, three-wire serial peripheral interface (SPI) or inter-integrated circuit (I2C), or may be serial communication using a differential signal such as Universal Serial Bus (USB) or peripheral component interconnect (PCI) express, or may be parallel communication such as Institute of Electrical and Electronics Engineers (IEEE) 1284, IDE, small computer system interface (SCSI), or PCI.

In the sheet feeding units 20_1 to 20_3 arranged in multiple stages as described above, when a sheet is fed from one sheet feeding unit 20, the sheet is conveyed to the apparatus body 10 through the other sheet feeding unit(s) 20 located above the one sheet feeding unit 20, in other words, adjacent to the apparatus body 10 relative to the one sheet feeding unit 20. For example, when a sheet loaded in the sheet feeding unit 20_2 is fed to the apparatus body 10, the sheet is conveyed from the sheet feeding unit 20_2 to the sheet feeding unit 20_1 by the motor M_2, and is further conveyed to the apparatus body 10 by the motor M_1 of the sheet feeding unit 20_1. In the image forming apparatus 1 having such a configuration, for example, when an abnormality such as a short circuit occurs in the peripheral device control board 21_1 of the sheet feeding unit 20_1 because of a foreign matter, the main control board 11 fails to communicate with the peripheral device control board 21_1. The peripheral device control board 21_1 also fails to operate and thus fails to control the motor M_1. Consequently, the sheet is no longer feedable from the sheet feeding unit 20_2 to the apparatus body 10. Accordingly, in the image forming apparatus 1, when an abnormality occurs in the peripheral device control board 21 of any sheet feeding unit 20, the motor M of the peripheral device control board 21 is controlled by the peripheral device control board 21 of another sheet feeding unit 20, thus enabling conveyance of a sheet to the apparatus body 10. This configuration will be specifically described.

### Circuit Configuration of Image Forming Apparatus

FIGS. 2A, 2B, and 2C, are diagrams illustrating circuit configurations of the main control board 11 and peripheral device control boards 21_1 of an image forming apparatus. A circuit configuration of the main control board 11 and the peripheral device control boards 21_1 and 21_2 of the image forming apparatus 1 will be described with reference to FIGS. 2A, 2B, and 2C, . In FIG. 2, description will be given assuming that two sheet feeding units 20 are arranged in multiple stages. The main control board 11, the peripheral device control board 21_1, and the peripheral device control board 21_2 serve as an "apparatus circuitry (first control apparatus)", a "first sheet-feeding circuitry (second control apparatus)", and a "second sheet-feeding circuitry (third control apparatus)," respectively.

The image forming apparatus 1 illustrated in FIG. 2 includes the main control board 11 for controlling the apparatus body 10 of the image forming apparatus 1, and the peripheral device control boards 21_1 and 21_2 for controlling sheet feeding operations of sheets of different types, for example, sheets of different materials or sizes, in the sheet feeding units 20_1 and 20_2, respectively. In the example of the image forming apparatus 1 illustrated in FIG. 2, the peripheral device control boards 21_1 and 21_2 are connected in series in this order from the main control board 11 by daisy-chain connection, and mutually perform data communication by a communication method that is two-wire serial communication of UART. That is, through such daisy-chain connection, the main control board 11 and the peripheral device control board 21_1 communicate with each other, and the peripheral device control board 21_1 and the peripheral device control board 21_2 communicate with each other.

Therefore, the main control board 11 and the peripheral device control board 21_2 perform data communication via the peripheral device control board 21_1. The apparatus body 10, the sheet feeding unit 20_1, and the sheet feeding unit 20_2 serve as an "apparatus body", a "first sheet feeder", and a "second sheet feeder," respectively.

As illustrated in FIG. 2, the main control board 11 includes the main SoC 101, a switching element 111, an integrated circuit (IC) circuit 112, a connector 121, a connector 122, a connector 131, a connector 132, a connector 136, a connector 137, and a resistor R1.

The main control board 11 may be equipped with components other than the components illustrated in FIG. 2.

The main SoC 101 is an arithmetic logic device that controls the entire main control board 11. The main SoC 101 is supplied with power from a power supply 140 to operate. Among input/output ports of the main SoC 101, a port Tx that is a transmission port and a port Rx that is a reception port are assigned to perform serial communication with the peripheral device control board 21_1. That is, the main SoC 101 of the main control board 11 and the sub SoC 201_1 (described below) perform data communication by two-wire asynchronous serial communication.

Instead of the main SoC 101, an arithmetic logic unit such as a microcontroller or a micro control unit (MCU) may be used.

The switching element 111 is a switching element that is driven by output from the port Tx of the main SoC 101 and has an open-drain or open-collector output format. For example, when the switching element 111 is a field effect transistor (FET), the switching element 111 has an open-drain output format. When the switching element 111 is a transistor, the switching element 111 has an open-collector output format. The switching element 111 has an output terminal that is a drain or collector. The output terminal is connected to the connector 121.

The IC circuit 112 is an IC circuit in which an input end is connected to the connector 122 and an output end is connected to the port Rx of the main SoC 101, and that performs processing such as buffering and noise cutting of a signal received from the sub SoC 201_1.

The connector 121 is a transmission connector for outputting, from the main control board 11, a signal transmitted from the port Tx of the main SoC 101 in serial communication between the main SoC 101 and the sub SoC 201_1. The connector 121 is connected, by a communication line, to a connector 221_1 (described below) of the peripheral device control board 21_1.

The connector 122 is a reception connector for inputting, from the peripheral device control board 21_1, a signal received at the port Rx of the main SoC 101 in serial communication between the main SoC 101 and the sub SoC 201_1. The connector 122 is connected, by a communication line, to a connector 222_1 (described below) of the peripheral device control board 21_1.

The connector 131 is a power-supply connector for supplying power from the power supply 140, which is a 5 [V] power supply in the main control board 11, to the peripheral device control board 21_1 and the peripheral device control board 21_2. The connector 131 is connected, by a power line, to a connector 231_1 (described below) of the peripheral device control board 21_1.

The connector 132 is a connector for frame ground (FG). The connector 132 is connected, by an FG line, to a connector 232_1 (described below) of the peripheral device control board 21_1.

The connector 136 is a power-supply connector for supplying power from a power supply 145, which is a 24 [V] power supply in the main control board 11, to the peripheral device control board 21_1 and the peripheral device control board 21_2. The connector 136 is connected, by a power line, to a connector 236_1 (described below) of the peripheral device control board 21_1.

The connector 137 is a connector for FG. The connector 137 is connected, by an FG line, to a connector 237_1 (described below) of the peripheral device control board 21_1.

The resistor R1 is a pull-up resistor for pulling up a reception line of the port Rx of the main SoC 101 by a 5 [V] power supply based on the power supply 140. In this case, for example, even when the power supply voltage of the main SoC 101 is not 5 [V], communication can be performed by voltage level conversion.

The power supply 140 is a 5 [V] power supply for supplying power to each device of the main control board 11.

The power supply 140 may be formed by directly supplying a voltage of 5 [V] from an external source. Alternatively, the power supply 140 may be formed by stepping down a predetermined voltage, for example, 24 [V], to 5 [V] by a direct-current (DC) converter included in the main control board 11, for example.

The power supply 145 is a 24 [V] power supply for supplying power to drive circuits for driving the motors M_1 and M_2 respectively controlled by the peripheral device control boards 21_1 and 21_2 that communicate with the main control board 11. The power supply 145 may further supply power for driving various actuators in the image forming device 12 of the apparatus body 10, for example. The power supply 145 may be formed by directly supplying a voltage of 24 [V] from an external source. Alternatively, the power supply 145 may be formed by stepping down a predetermined voltage to 24 [V] by a DC converter included in the main control board 11, for example.

As illustrated in FIG. 2, the peripheral device control board 21_1 includes the sub SoC 201_1, an IC circuit 211_1, a switching element 212_1, the connector 221_1, the connector 222_1, the connector 231_1, the connector 232_1, the connector 236_1, the connector 237_1, a switching element 241_1, an IC circuit 242_1, a connector 251_1, a connector 252_1, a fuse 272_1, a fuse 277_1, a connector 261_1, a connector 262_1, a connector 266_1, a connector 267_1, a detection circuit 290_1, a resistor R2, a resistor R3, a changeover switch 291_1, and a changeover switch 292_1. The peripheral device control board 21_1 may be equipped with components other than the components illustrated in FIG. 2.

The sub SoC 201_1 is an arithmetic device that controls the entire peripheral device control board 21_1.

The sub SoC 201_1 is supplied with power from a power supply 271_1 (described below) to operate. Among input/output ports of the sub SoC 201_1, a port Tx that is a transmission port and a port Rx that is a reception port are assigned to perform serial communication with the main control board 11. That is, the main SoC 101 of the main control board 11 and the sub SoC 201_1 perform data communication by two-wire asynchronous serial communication. Among the input/output ports of the sub SoC 201_1, a port Tx2 that is a transmission port and a port Rx2 that is a reception port are assigned to perform serial communication with the peripheral device control board 21_2. That is, the sub SoC 201_1 of the peripheral device control board 21_1 and the sub SoC 201_2 (described below) of the peripheral device control board 21_2 perform data communication by two-wire asynchronous serial communication.

Instead of the sub SoC 201_1, an arithmetic device such as a controller may be used.

The IC circuit 211_1 is an IC circuit in which an input end is connected to a terminal T2 of the changeover switch 291_1 and an output end is connected to the port Rx of the sub SoC 201_1, and that performs processing such as buffering and noise cutting of a signal received from the main SoC 101.

The switching element 212_1 is a switching element that is driven by output from the port Tx of the sub SoC 201_1 and has an open-drain or open-collector output format. For example, when the switching element 212_1 is a FET, the switching element 212_1 has an open-drain output format. When the switching element 212_1 is a transistor, the switching element 212_1 has an open-collector output format. The switching element 212_1 has an output terminal that is a drain or collector. The output terminal is connected to the terminal T2 of the changeover switch 292_1.

The connector 221_1 is a reception connector for inputting, from the main control board 11, a signal received at the port Rx of the sub SoC 201_1 in serial communication between the main SoC 101 and the sub SoC 201_1. The connector 221_1 is connected to a terminal T1 of the changeover switch 291_1. The connector 221_1 is connected, by a communication line, to the connector 121 of the main control board 11.

The connector 222_1 is a transmission connector for outputting, from the peripheral device control board 21_1, a signal transmitted from the port Tx of the sub SoC 201_1 in serial communication between the main SoC 101 and the sub SoC 201_1. The connector 222_1 is connected to a terminal T1 of the changeover switch 292_1. The connector 222_1 is connected, by a communication line, to the connector 122 of the main control board 11.

The connector 231_1 is a power-supply connector for receiving 5 [V] power from the main control board 11 and forming a power supply 270_1. The connector 231_1 is connected, by a power line, to the connector 131 of the main control board 11.

The connector 232_1 is a connector for FG. The connector 232_1 is connected, by an FG line, to the connector 132 of the main control board 11.

The connector 236_1 is a power-supply connector for receiving 24 [V] power from the main control board 11 and forming a power supply 275_1. The connector 236_1 is connected, by a power line, to the connector 136 of the main control board 11.

The connector 237_1 is a connector for FG. The connector 237_1 is connected, by an FG line, to the connector 137 of the main control board 11.

The fuse 272_1 is a power supply fuse for circuit protection when an overcurrent occurs because of a short circuit caused by a foreign matter in the peripheral device control board 21_1, and is a member that forms a power supply 271_1 ("+5V_F1") that enables circuit protection based on the power supply 270_1. When a short circuit occurs in the peripheral device control board 21_1 because of a foreign matter, the fuse 272_1 is blown to protect the circuit of the peripheral device control board 21_1. Instead of the fuse 272_1, a switch such as a PolySwitch^{®} or a load switch having a similar function may be used. The fuse 272_1 serves as a "cutoff circuit."

The power supply 270_1 is a power supply formed by 5 [V] power from the main control board 11. The power supply 270_1 forms the power supply 271_1 through the fuse 272_1.

The power supply 271_1 is a 5 [V] power supply for supplying power to each device of the peripheral device control board 21_1. Therefore, when the fuse 272_1 is blown, power supply from the power supply 271_1 stops. Consequently, the sub SoC 201_1 stops operation and fails to perform serial communication with the main SoC 101.

The fuse 277_1 is a power supply cutoff circuit for circuit protection when an overcurrent occurs because of a short circuit caused by a foreign matter on the peripheral device control board 21_1, and is a member that forms a power supply 276_1 ("+24V_F1") that enables circuit protection based on the power supply 275_1. When a short circuit occurs in the peripheral device control board 21_1 because of a foreign matter, the fuse 277_1 is blown to protect the circuit of the peripheral device control board 21_1. Instead of the fuse 277_1, a switch such as a PolySwitch^{®} or a load switch having a similar function may be used.

The power supply 275_1 is a power supply formed by 24 [V] power from the main control board 11. The power supply 275_1 forms the power supply 276_1 through the fuse 277_1.

The power supply 276_1 is a 24 [V] power supply for supplying power to each device of the peripheral device control board 21_1. Therefore, when the fuse 277_1 is blown, power supply from the power supply 276_1 stops.

The switching element 241_1 is a switching element that is driven by output from the port Tx2 of the sub SoC 201_1 and has an open-drain or open-collector output format. For example, when the switching element 241_1 is a FET, the switching element 241_1 has an open-drain output format. When the switching element 241_1 is a transistor, the switching element 241_1 has an open-collector output format. The switching element 241_1 has an output terminal that is a drain or collector. The output terminal is connected to the connector 251_1. The switching element 241_1 supports partial power-down. Even when the switching element 241_1 is not supplied with power from the power supply 271_1, application of a voltage to input/output terminals causes no problem.

The IC circuit 242_1 is an IC circuit in which an input end is connected to the connector 252_1 and an output end is connected to the port Rx2 of the sub SoC 201_1, and that performs processing such as buffering and noise cutting of a signal received from the sub SoC 201_2 (described below). The IC circuit 242_1 supports partial power-down. Even when the IC circuit 242_1 is not supplied with power from the power supply 271_1, application of a voltage to input/output terminals causes no problem.

The connector 251_1 is a transmission connector for outputting, from the peripheral device control board 21_1, a signal transmitted from the port Tx2 of the sub SoC 201_1 in serial communication between the sub SoC 201_1 and the sub SoC 201_2. The connector 251_1 is connected, by a communication line, to a connector 221_2 (described below) of the peripheral device control board 21_2.

The connector 252_1 is a reception connector for inputting, from the peripheral device control board 21_2, a signal received at the port Rx2 of the sub SoC 201_1 in serial communication between the sub SoC 201_1 and the sub SoC 201_2. The connector 252_1 is connected, by a communication line, to a connector 222_2 (described below) of the peripheral device control board 21_2.

The connector 261_1 is a power-supply connector for supplying power from the power supply 270_1, which is a 5 [V] power supply in the peripheral device control board 21_1, to the peripheral device control board 21_2. The connector 261_1 is connected, by a power line, to a connector 231_2 (described below) of the peripheral device control board 21_2.

The connector 262_1 is a connector for FG. The connector 262_1 is connected, by an FG line, to a connector 232_2 (described below) of the peripheral device control board 21_2.

The connector 266_1 is a power-supply connector for supplying power from the power supply 275_1, which is a 24 [V] power supply in the peripheral device control board 21_1, to the peripheral device control board 21_2. The connector 266_1 is connected, by a power line, to a connector 236_2 (described below) of the peripheral device control board 21_2.

The connector 267_1 is a connector for FG. The connector 267_1 is connected, by an FG line, to a connector 237_2 (described below) of the peripheral device control board 21_2.

The detection circuit 290_1 is a circuit for detecting that the fuse 272_1 has been blown because a short circuit has occurred in the peripheral device control board 21_1 because of a foreign matter. The detection circuit 290_1 includes a transistor 290a and a resistor R4. The transistor 290a has an emitter that is grounded, a collector connected to one end of the resistor R4, and a base connected to the power supply 271_1. One end of the resistor R4 is connected to the collector of the transistor 290a. The other end of the resistor R4 is connected to the power supply 270_1. A connection portion between the one end of the resistor R4 and the collector of the transistor 290a is connected, by a connection line blown_fuse, to input ports of the changeover switches 291_1 and 292_1.

In this case, when the fuse 272_1 is not blown, power supply from the power supply 271_1 is enabled. Thus, the transistor 290a is on, and the signal level of the connection line blown_fuse is low. By contrast, when the fuse 272_1 is blown, the transistor 290a is not driven from the power supply 271_1 and thus is off. Therefore, the signal level of the connection line blown_fuse is high. That is, when the detection circuit 290_1 detects that the fuse 272_1 is blown, the detection circuit 290_1 inverts the signal level of the connection line blown_fuse from the low level to the high level. The connection line blown_fuse is connected to the input ports of the changeover switches 291_1 and 292_1 as described above. The changeover switches 291_1 and 292_1, as described later, switch contacts in accordance with the detection result about blowing of the fuse 272_1 obtained by the detection circuit 290_1, that is, the signal level of the connection line blown_fuse. Thus, an overcurrent in the sheet feeding unit 20_1 (first sheet feeder) is detected.

The circuitry of the detection circuit 290_1 illustrated in FIG. 2 is merely an example, and any circuitry that implements the functions described above may be used.

The resistor R2 is a pull-up resistor for pulling up a reception line of the port Rx of the sub SoC 201_1 by a 5 [V] power supply based on the power supply 271_1.

The resistor R3 is a pull-up resistor for pulling up a reception line of the port Rx2 of the sub SoC 201_1 by the 5 [V] power supply based on the power supply 271_1.

In this case, for example, even when the power supply voltage of the sub SoC 201_1 is not 5 [V], communication can be performed by voltage level conversion.

The changeover switch 291_1 is an electronic component that switches contacts to cause a signal transmitted from the main SoC 101 and passing through the connector 221_1 to be received at the port Rx of the sub SoC 201_1 or to be transmitted to a communication line Tx_thr by skipping the sub SoC 201_1. As illustrated in FIG. 2, the changeover switch 291_1 includes terminals T1 to T3.

The terminal T1 is connected to the connector 221_1. The terminal T2 is connected to the input end of the IC circuit 211_1. The terminal T3 is connected to the communication line Tx_thr. When the signal level of the connection line blown_fuse connected to the input side is the low level, the changeover switch 291_1 determines that the fuse 272_1 is not blown, and switches contacts such as the terminal T1 and the terminal T2 are connected to each other. When the signal level of the connection line blown_fuse connected to the input side is the high level, the changeover switch 291_1 determines that the fuse 272_1 is blown, and switches contacts such that the terminal T1 and the terminal T3 are connected to each other.

The changeover switch 292_1 is an electronic component that switches contacts to transmit a signal transmitted from the sub SoC 201_1 and passing through the connector 222_1 to the main SoC 101, or to transmit, to the main SoC 101 via the connector 222_1, a signal passing through a communication line Rx_thr by skipping the sub SoC 201_1. As illustrated in FIG. 2, the changeover switch 292_1 includes terminals T1 to T3. The terminal T1 is connected to the connector 222_1. The terminal T2 is connected to the output side of the switching element 212_1. The terminal T3 is connected to the communication line Rx_thr. When the signal level of the connection line blown_fuse connected to the input side is the low level, the changeover switch 292_1 determines that the fuse 272_1 is not blown, and switches contacts such that the terminal T1 and the terminal T2 are connected to each other. When the signal level of the connection line blown_fuse connected to the input side is the high level, the changeover switch 292_1 determines that the fuse 272_1 is blown, and switches contacts such that the terminal T1 and the terminal T3 are connected to each other. A signal indicated by the signal level of the connection line blown_fuse may be referred to as a detection signal below.

The changeover switches 291_1 and 292_1 each correspond to an example of a "second switch."

As illustrated in FIG. 2, the peripheral device control board 21_1 further includes the drive circuit 281_1, the drive circuit 282_1, the selector 283_1, a connector 225_1, and a connector 255_1.

The drive circuit 281_1 is a drive circuit for driving a motor M driven by a peripheral device control board 21 located closer to the main control board 11 than the peripheral device control board 21_1 in daisy-chain connection, in accordance with control by the sub SoC 201_1, in place of the peripheral device control board 21. In this case, there is no peripheral device control board 21 located closer to the main control board 11 than the peripheral device control board 21_1. The drive circuit 281_1 is supplied with power from the power supply 276_1 to operate.

The drive circuit 282_1 is a drive circuit for driving the motor M_1 in accordance with control by the sub SoC 201_1. The drive circuit 282_1 can drive the motor M_1 when the selector 283_1 switches the drive path for the motor M_1 such that a drive current from the drive circuit 282_1 is transmitted to the motor M_1. The drive circuit 282_1 is supplied with power from the power supply 276_1 to operate. Therefore, when the fuse 277_1 is blown because an abnormality such as a short circuit occurs in the peripheral device control board 21_1 because of a foreign matter, power supply from the power supply 276_1 stops and the drive circuit 282_1 fails to drive the motor M_1. The motor M_1 serves as a "conveyance motor." The drive circuit 282_1 serves as a "first drive circuit."

The selector 283_1 is a component that receives a signal of the connection line blown_fuse, and switches between a first path in which the motor M_1 is supplied with a drive current output from the drive circuit 282_1 and a second path in which the motor M_1 is supplied with a drive current from an outside via the connector 255_1. Specifically, when the detection signal is at the low level, the selector 283_1 assumes that the fuse 272_1 is not blown and the peripheral device control board 21_1 is operating normally, and switches the drive path to the first drive path in which the motor M_1 is supplied with the drive current from the drive circuit 282_1 included in the peripheral device control board 21_1. By contrast, when the detection signal is at the high level, the selector 283_1 assumes that the fuse 272_1 is blown and the peripheral device control board 21_1 does not operate normally, and switches the drive path to the second drive path in which the motor M_1 is supplied with the drive current from outside, for example, the peripheral device control board 21_2, via the connector 255_1. Since the selector 283_1 is supplied with power from the power supply 270_1, the selector 283_1 operates normally when the fuse 272_1 is blown. The selector 283_1 serves as a "first switch."

The connector 225_1 is a connector that is connected to the drive circuit 281_1 and outputs, to an outside, the drive current output from the drive circuit 281_1.

The connector 255_1 is a connector that is connected to the selector 283_1, receives a drive current for driving the motor M_1 supplied from outside, and sends the drive current to the selector 283_1.

As illustrated in FIG. 2, the peripheral device control board 21_2 includes the sub SoC 201_2, an IC circuit 211_2, a switching element 212_2, the connector 221_2, the connector 222_2, the connector 231_2, the connector 232_2, the connector 236_2, the connector 237_2, a switching element 241_2, an IC circuit 242_2, a connector 251_2, a connector 252_2, a fuse 272_2, a fuse 277_2, a connector 261_2, a connector 262_2, a connector 266_2, a connector 267_2, a detection circuit 290_2, a resistor R2, a resistor R3, a changeover switch 291_2, and a changeover switch 292_2. As illustrated in FIG. 2, the peripheral device control board 21_2 further includes the drive circuit 281_2, the drive circuit 282_2, the selector 283_2, a connector 225_2, and a connector 255_2. Operations of these components are substantially the same as operations of the corresponding components in the peripheral device control board 21_1 described above. The peripheral device control board 21_2 may be equipped with components other than the components illustrated in FIG. 2. The components of the peripheral device control boards 21_1 and 21_2 may be referred to simply as a sub SoC 201, an IC circuit 211, a switching element 212, a connector 221, a connector 222, a connector 231, a connector 232, a connector 236, a connector 237, a switching element 241, an IC circuit 242, a connector 251, a connector 252, a fuse 272, a fuse 277, a connector 261, a connector 262, a connector 266, a connector 267, a detection circuit 290, a changeover switch 291, a changeover switch 292, a drive circuit 281, a drive circuit 282, a selector 283, a connector 225, and a connector 255 when any one of the corresponding components is referred to or when the corresponding components are collectively referred to.

A power supply 270_2 is a power supply formed by 5 [V] power from the peripheral device control board 21_1. The power supply 270_2 forms a power supply 271_2 through the fuse 272_2.

The power supply 271_2 is a 5 [V] power supply for supplying power to each device on the peripheral device control board 21_2. Therefore, when the fuse 272_2 is blown, power supply from the power supply 271_2 stops. Consequently, the sub SoC 201_2 stops operation and fails to perform serial communication with the sub SoC 201_1.

The power supply 275_2 is a power supply formed by 24 [V] power from the peripheral device control board 21_1. The power supply 275_2 forms a power supply 276_2 through the fuse 277_2.

The power supply 276_2 is a 24 [V] power supply for supplying power to each device on the peripheral device control board 21_2. Therefore, when the fuse 277_2 is blown, power supply from the power supply 276_2 stops.

The drive circuit 281_2 is a drive circuit for driving a motor M driven by a peripheral device control board 21 located closer to the main control board 11 than the peripheral device control board 21_2 in daisy-chain connection, in accordance with control by the sub SoC 201_2, in place of the peripheral device control board 21. In this case, the peripheral device control board 21_1 is the peripheral device control board 21 located closer to the main control board 11 than the peripheral device control board 21_2. The drive circuit 281_2 is supplied with power from the power supply 276_2 to operate. The drive circuit 281_2 serves as a "second drive circuit."

The drive circuit 282_2 is a drive circuit for driving the motor M_2 in accordance with control by the sub SoC 201_2. The drive circuit 282_2 can drive the motor M_2 when the selector 283_2 switches a path such that a drive current from the drive circuit 282_2 is transmitted to the motor M_2. The drive circuit 282_2 is supplied with power from the power supply 276_2 to operate. Therefore, when the fuse 277_2 is blown because an abnormality such as a short circuit occurs in the peripheral device control board 21_2 because of a foreign matter, power supply from the power supply 276_2 stops and the drive circuit 282_2 fails to drive the motor M_2.

The selector 283_2 is a component that receives a signal of the connection line blown_fuse, and switches between a path for supplying the motor M_2 with a drive current output from the drive circuit 282_2 and a path for supplying the motor M_2 with a drive current supplied from outside via the connector 255_2. Specifically, when the detection signal is at the low level, the selector 283_2 assumes that the fuse 272_2 is not blown and the peripheral device control board 21_2 is operating normally, and switches the drive path to the first drive path for supplying the motor M_2 with the drive current output from the drive circuit 282_2 included in the peripheral device control board 21_2. By contrast, when the detection signal is at the high level, the selector 283_2 assumes that the fuse 272_2 is blown and the peripheral device control board 21_2 does not operate normally, and switches the drive path to the second drive path for supplying the motor M_2 with the drive current supplied from an outside via the connector 255_2. Since the selector 283_2 is supplied with power from the power supply 270_2, the selector 283_2 operates normally when the fuse 272_2 is blown.

The connectors that connect the main control board 11 and the peripheral device control board 21_1 to each other and connect the peripheral device control board 21_1 and the peripheral device control board 21_2 to each other may use, for example, a harness or a flexible flat cable (FFC) for connection.

### Overview of Operation of Image Forming Apparatus

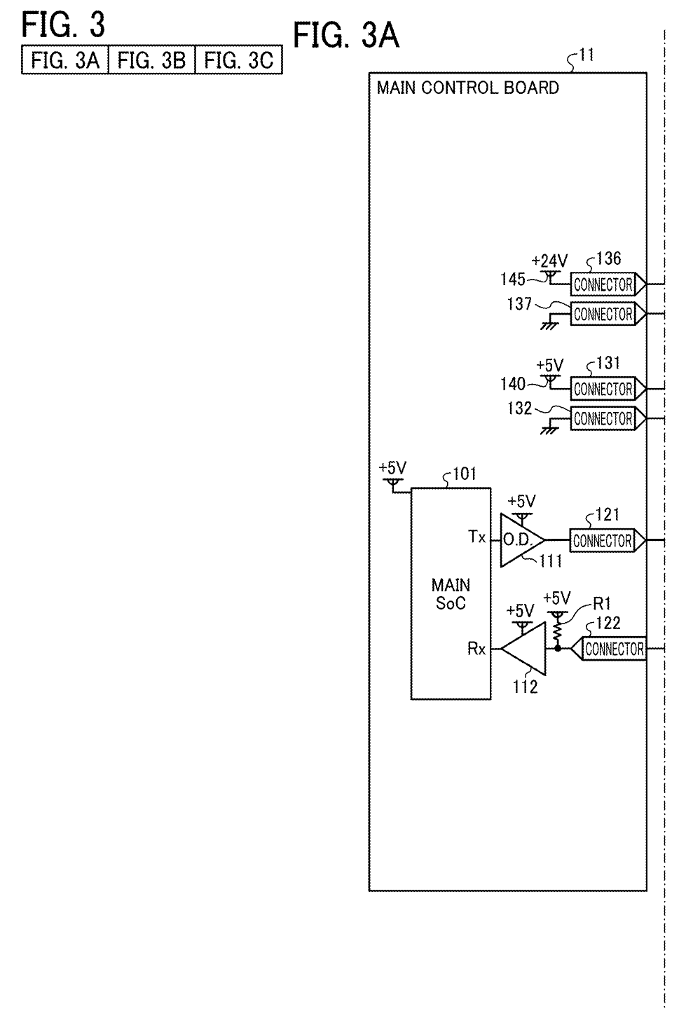

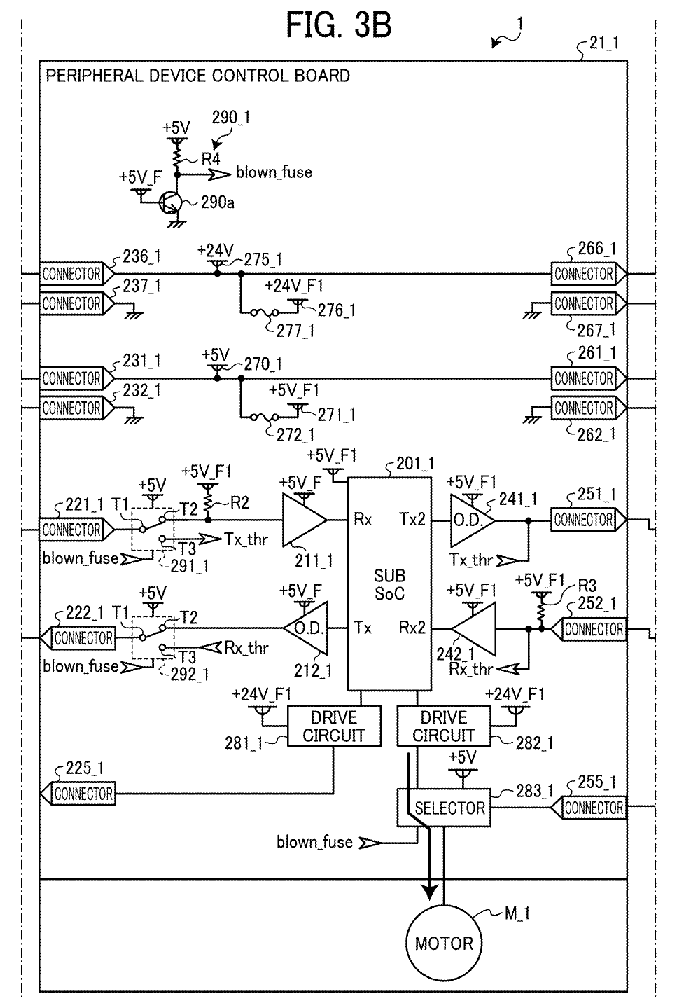

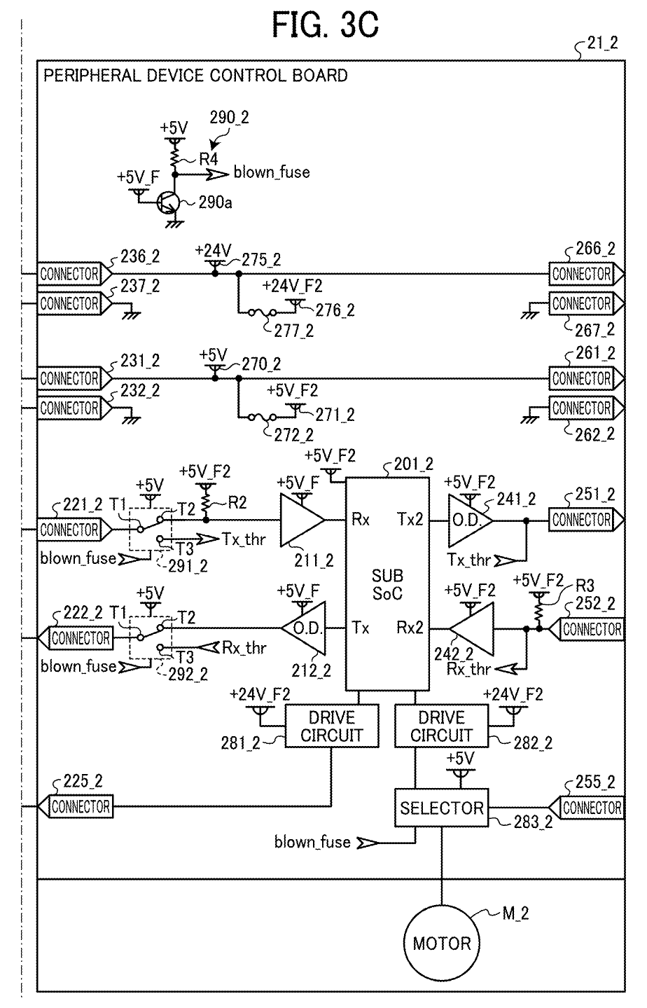

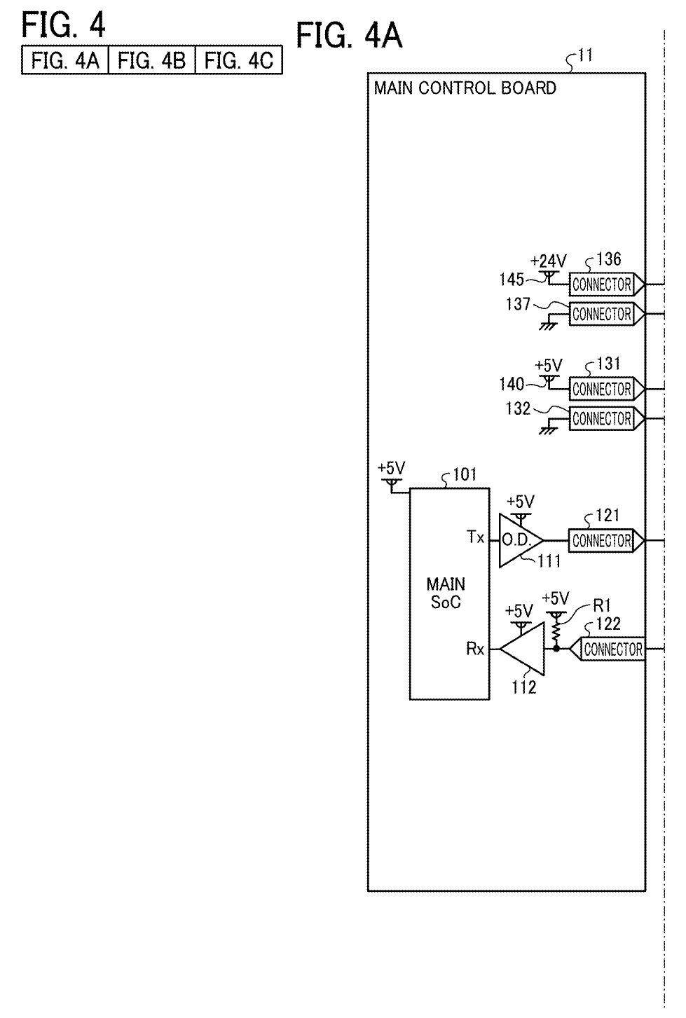

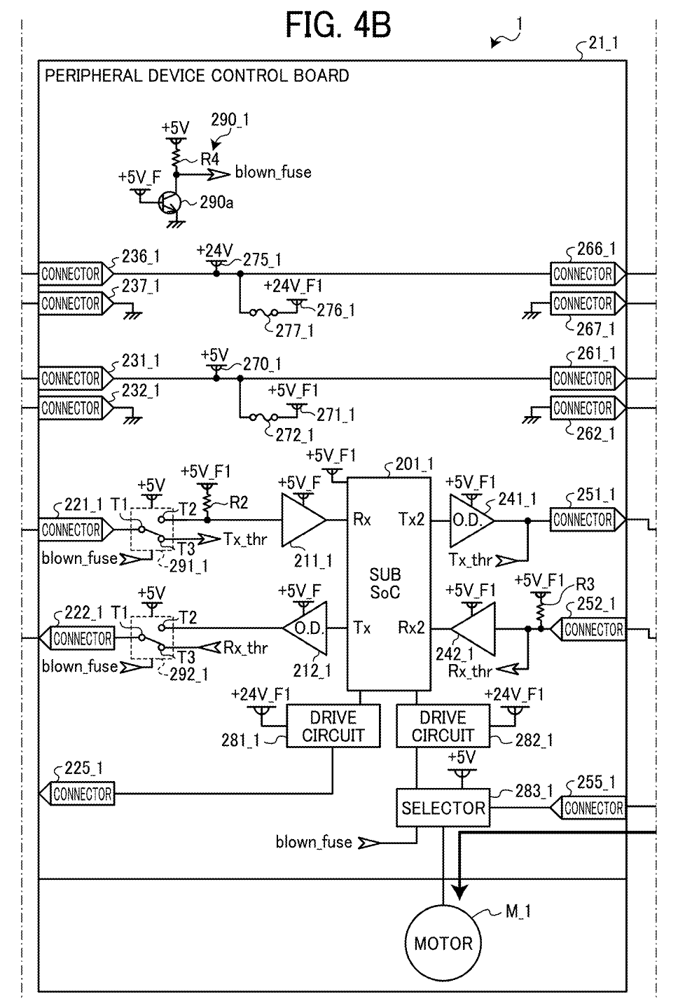

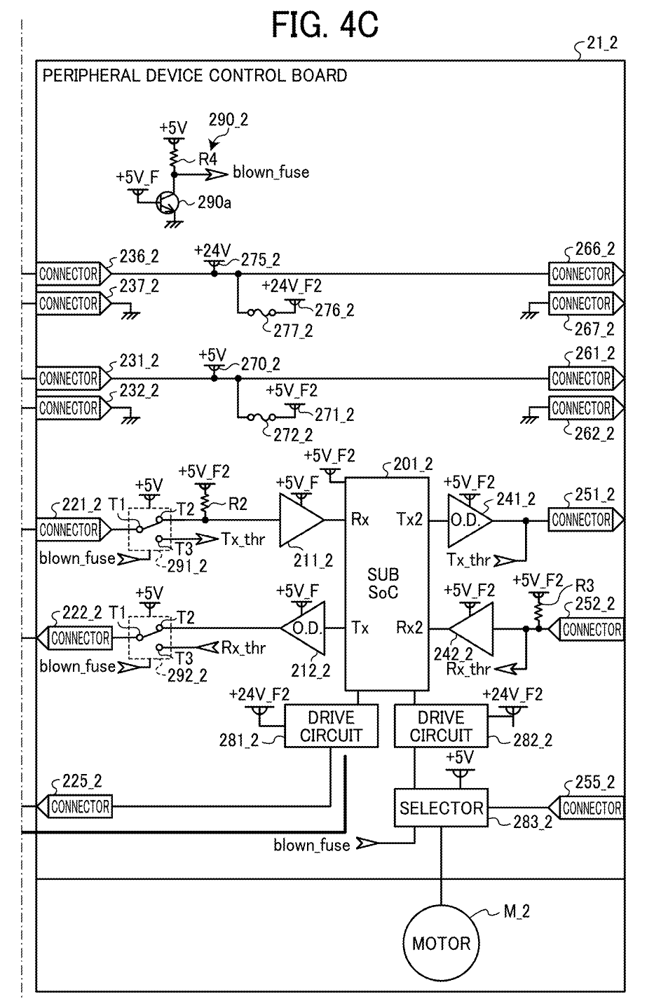

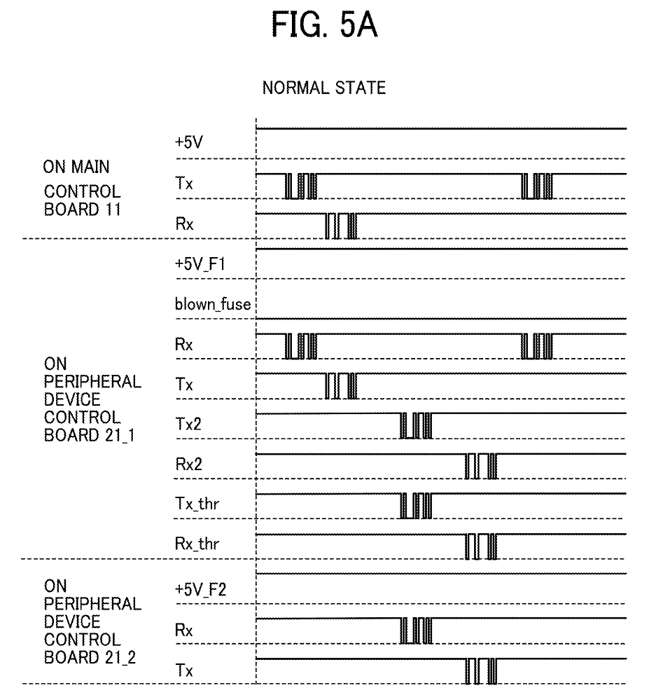

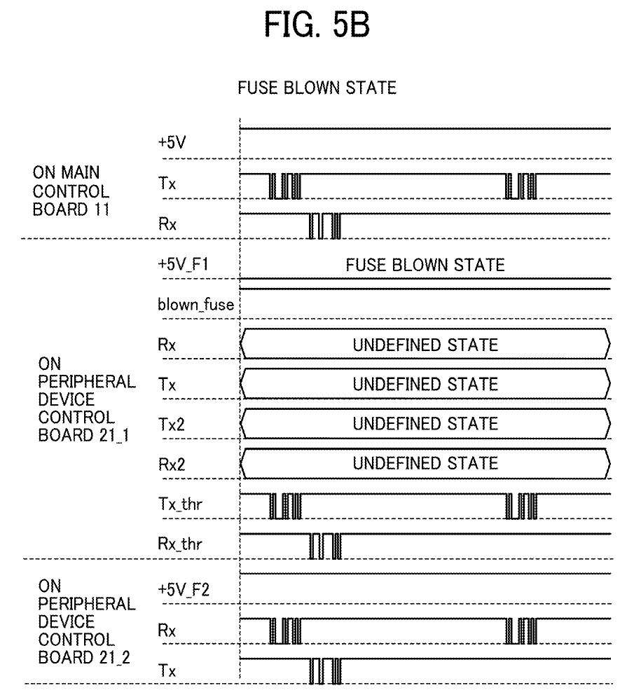

FIGS. 3A, 3B, and 3C, (FIG. 3) are diagrams illustrating a circuit configuration of the image forming apparatus 1 in a normal state. FIGS. 4A, 4B. and 4C, (FIG. 4) are diagrams illustrating a circuit configuration of the image forming apparatus 1 in which a fuse is blown. FIGS. 5A and 5B are timing charts each illustrating a communication operation between the main control board 11 and the peripheral device control board 21_1 of the image forming apparatus 1. The overview of the operation of the image forming apparatus 1 will be described with reference to FIGS. 3-5B.

Suppose that in the configuration of the image forming apparatus 1 illustrated in FIG. 2, the peripheral device control board 21_1 does not include the changeover switches 291_1 and 292_1, that is, the connector 221_1 and the input end of the IC circuit 211_1 are directly connected to each other and the connector 222_1 and the output end of the switching element 212_1 are directly connected to each other. In this case, when the fuse 272_1 is blown, the sub SoC 201_1 stops operating although the peripheral device control board 21_2 is free from an abnormality and is ready to operate normally. Thus, the main SoC 101 fails to communicate with the sub SoC 201_2 located downstream from the sub SoC 201_1. Since the sub SoC 201_1 stops operating, the sub SoC 201_1 fails to control driving of the motor M_1. Thus, a sheet is not feedable to the apparatus body 10 from the sheet feeding unit 20_2 that is farther from the apparatus body 10 than the sheet feeding unit 20_1, that is, located at a lower position than the sheet feeding unit 20_1. Accordingly, the peripheral device control board 21_1 includes the changeover switches 291_1 and 292_1 and the selector 283_1 that switches the path of the drive current as described above with reference to FIG. 2. Likewise, the peripheral device control board 21_2 also includes the changeover switches 291_2 and 292_2 and the selector 283_2 that switches the path of the drive current. The operation of the image forming apparatus 1 will be described in detail below focusing on the peripheral device control board 21_1.

In the normal state where the fuse 272_1 is not blown, since the detection signal from the detection circuit 290_1 is at the low level, the changeover switches 291_1 and 292_1 each switch contacts such that the terminal T1 and the terminal T2 are connected to each other as illustrated in FIG. 3. As a result, the power supply 271_1 has the same voltage as the power supply 270_1 as illustrated in FIG. 5A, the connector 221_1 and the input end of the IC circuit 211_1 are connected to each other, and the connector 222_1 and the output end of the switching element 212_1 are connected to each other. Accordingly, as illustrated in FIG. 5A, data communication is respectively performed between the port Tx and the port Rx of the main SoC 101 and the port Rx and the port Tx of the sub SoC 201_1, and data communication is respectively performed between the port Tx2 and the port Rx2 of the sub SoC 201_1 and the port Rx and the port Tx of the sub SoC 201_2. That is, when the main SoC 101 of the main control board 11 performs data communication with the sub SoC 201_2 of the peripheral device control board 21_2, the main SoC 101 performs data communication via the sub SoC 201_1 of the peripheral device control board 21_1.

In the normal state where the fuse 272_1 is not blown, since the detection signal is at the low level, the selector 283_1 switches the path to the path for supplying the motor M_1 with the drive current output from the drive circuit 282_1 included in the peripheral device control board 21_1. That is, in the normal state where the fuse 272_1 is not blown, since the sub SoC 201_1 is operating normally, the sub SoC 201_1 controls driving of the motor M_1 via the drive circuit 282_1.

By contrast, when the fuse 272_1 is blown, since the detection signal from the detection circuit 290_1 is at the high level, the changeover switches 291_1 and 292_1 each switch contacts such that the terminal T1 and the terminal T3 are connected to each other as illustrated in FIG. 4. As a result, power supply to the power supply 271_1 from the power supply 270_1 stops as illustrated in FIG. 5B, the connector 221_1 and the communication line Tx_thr, that is, the connector 251_1, are connected to each other, and the connector 222_1 and the communication line Rx_thr, that is, the connector 252_1, are connected to each other. Accordingly, as illustrated in FIG. 5B, direct data communication is respectively performed between the port Tx and the port Rx of the main SoC 101 and the port Rx and the port Tx of the sub SoC 201_2. That is, the main SoC 101 of the main control board 11 directly performs data communication with the sub SoC 201_2 of the peripheral device control board 21_2 without using (by skipping) the sub SoC 201_1 of the peripheral device control board 21_1. In this manner, even when power supply from the main control board 11 to the peripheral device control board 21_1 connected by daisy-chain connection stops, the main control board 11 can communicate with the peripheral device control board 21_2 located downstream and connected by daisy-chain connection.

When the fuse 272_1 is blown, the detection signal has the high level. Thus, the selector 283_1 assumes that the peripheral device control board 21_1 does not operate normally, and switches the path to the path for supplying the motor M_1 with the drive current supplied from the peripheral device control board 21_2, more specifically, the drive circuit 281_2 via the connector 225_2 of the peripheral device control board 21_2 and the connector 255_1 of the peripheral device control board 21_1. This allows the sub SoC 201_2 of the peripheral device control board 21_2 to control driving of the motor M_1 of the peripheral device control board 21_1 via the drive circuit 281_2, as a substitute for the sub SoC 201_1 that is inoperable. Consequently, a sheet taken out from the sheet feeding unit 20_2 is fed to the apparatus body 10 via the sheet feeding unit 20_1 by driving of the motor M_1.

In the configuration of the image forming apparatus 1 illustrated in FIGS. 2-4, two peripheral device control boards 21 are daisy-chain connected. However, the configuration is not limited to this example, and three or more peripheral device control boards 21 having a similar configuration may be daisy-chain connected. The term "similar configuration" indicates that the peripheral device control boards 21 use the same communication method and includes the fuse 272, the changeover switches 291 and 292, the detection circuit 290, the drive circuits 281 and 282, and the selector 283, and may be different in the other configurations.

The peripheral device control board 21 in which the fuse 272 is blown may be referred to as an abnormal control board. In this case, the sub SoC 201 of the upstream peripheral device control board 21 adjacent to the abnormal control board, that is, the peripheral device control board 21 closer to the main control board 11, communicates with the sub SoC 201 of a downstream peripheral device control board 21 adjacent to the abnormal control board. The sub SoC 201 of the downstream peripheral device control board 21 adjacent to the abnormal control board controls driving of the motor M of the abnormal control board via the drive circuit 281 of the downstream peripheral device control board 21, as a substitute for the sub SoC 201 of the abnormal control board.

The motor M of the abnormal control board is driven by the drive circuit 281 of the downstream peripheral device control board 21 adjacent to the abnormal control board. However, the peripheral device control board 21 including the drive circuit 281 that drives the motor M is not limited to the downstream peripheral device control board 21. That is, the motor M of the abnormal control board may be driven by the drive circuit 281 of the upstream peripheral device control board 21 adjacent to the abnormal control board.

As described above, even when one of fuses 272 on the peripheral device control boards 21 connected by daisy-chain connection is blown, data communication can be continued by skipping the peripheral device control board 21, namely, the abnormal control board, and the motor M of the abnormal control board can be driven by the drive circuit 281 of the peripheral device control board 21 adjacent to the abnormal control board. Even when the fuse 272 is blown in a plurality of consecutive or intermittent peripheral device control boards 21, data communication can be performed between other peripheral device control boards 21 by skipping the abnormal control boards in which the fuse 272 is blown.

### Operation Procedure of Main SoC

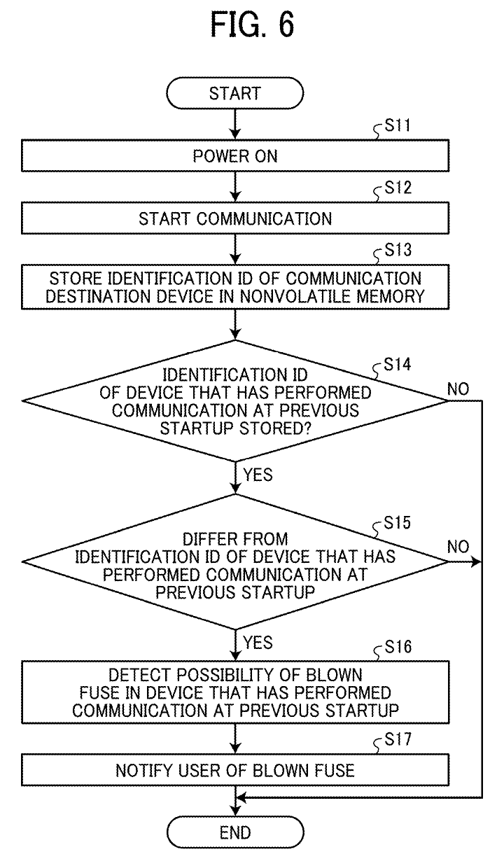

FIG. 6 is a flowchart illustrating an example of an operation procedure of a main SoC of an image forming apparatus. The operation procedure of the main SoC 101 of the image forming apparatus 1 will be described with reference to FIG. 6.

### Step S11

The image forming apparatus 1 is powered on. The process then proceeds to step S12.

### Step S12

The main SoC 101 of the main control board 11 starts data communication with the peripheral device control boards 21 connected by daisy-chain connection. The process then proceeds to step S13.

### Step S13

In exchange by data communication, the main SoC 101 acquires an identification ID of the sheet feeding unit 20 having the peripheral device control board 21 that is communication destination, and stores the acquired identification ID in a nonvolatile memory or storage included in the main SoC 101. The storage for storing the device ID may be an external storage. The identification ID of the sheet feeding unit 20 may be information indicating a type of the sheet feeding unit 20 other than the ID of the device. The process then proceeds to step S14.

### Step S14

The main SoC 101 determines whether the nonvolatile memory stores the identification ID of the sheet feeding unit 20 having the peripheral device control board 21 that has performed data communication at the previous startup. When the identification ID is stored (step S14: Yes), the process proceeds to step S15. When the identification ID is not stored (step S14: No), the process ends since this startup is an initial startup after installation of the image forming apparatus 1.

### Step S15

The main SoC 101 determines whether the identification ID of the sheet feeding unit 20 having the peripheral device control board 21 that has performed data communication at the previous startup differs from the identification ID acquired in step S13. When the identification IDs differ from each other (step S15: Yes), the process proceeds to step S16. When the identification IDs match (step S15: No), the process ends since the configuration of daisy-chain connection is not changed in the image forming apparatus 1 from the previous startup.

### Step S16

When the identification IDs differ from each other, the main SoC 101 detects that the fuse 272 may be blown in any of the peripheral device control boards 21 that have performed data communication at the previous startup. The process then proceeds to step S17.

### Step S17

The identification IDs may be different from each other in a case where a failure has occurred in the peripheral device control board 21 or a case where a user has intentionally removed the peripheral device control board 21 in addition to a case where the fuse 272 is blown. Therefore, the main SoC 101 displays, on the liquid crystal panel 13a of the operation device 13 of the image forming apparatus 1, an indication that the main SoC 101 has detected a possibility of the fuse 272 being blown in any one of the peripheral device control boards 21 that have performed data communication at the previous startup to notify the user of the detected possibility. The notification may be made, for example, by sending an email. Accordingly, it is easily determined whether the peripheral device control board 21 has a blown fuse 272, has a failure, or has been intentionally removed, for example. The process then ends.

### Procedure of Sheet Feeding Operation of Image Forming Apparatus

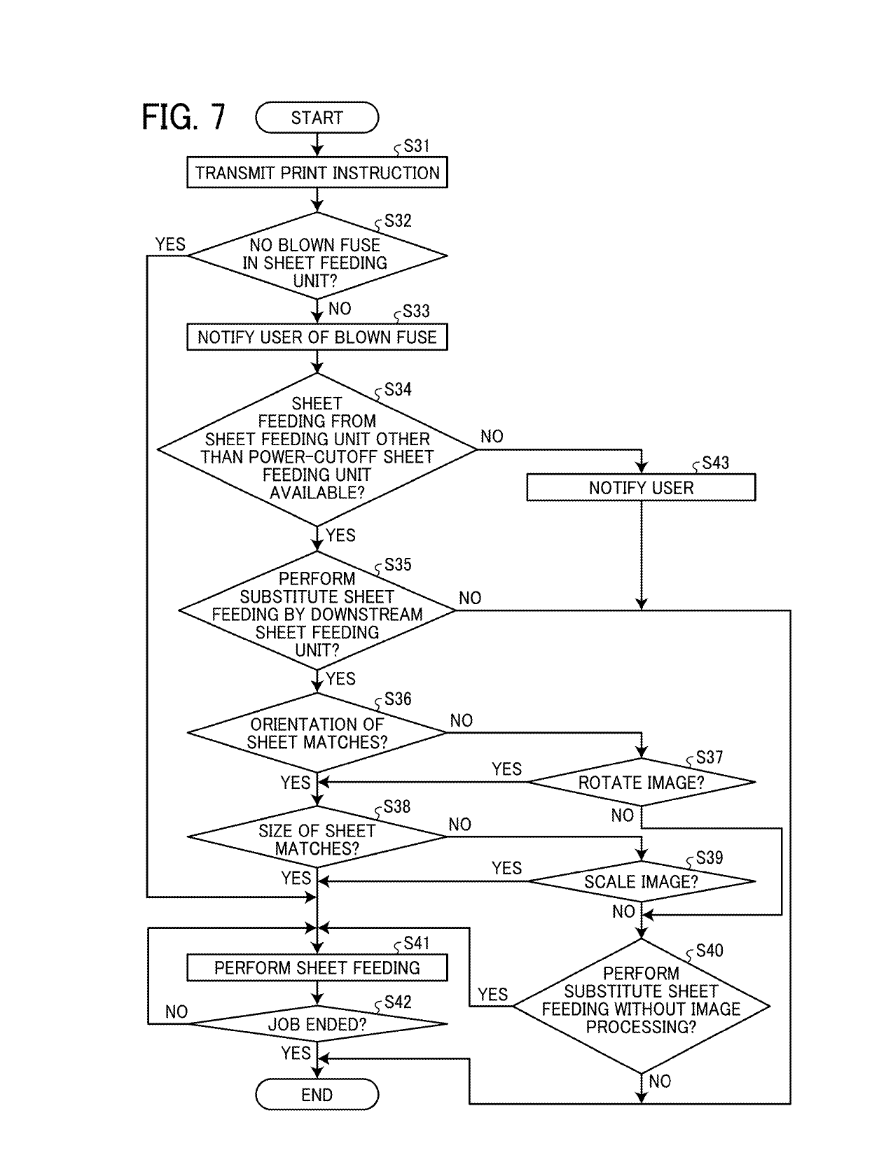

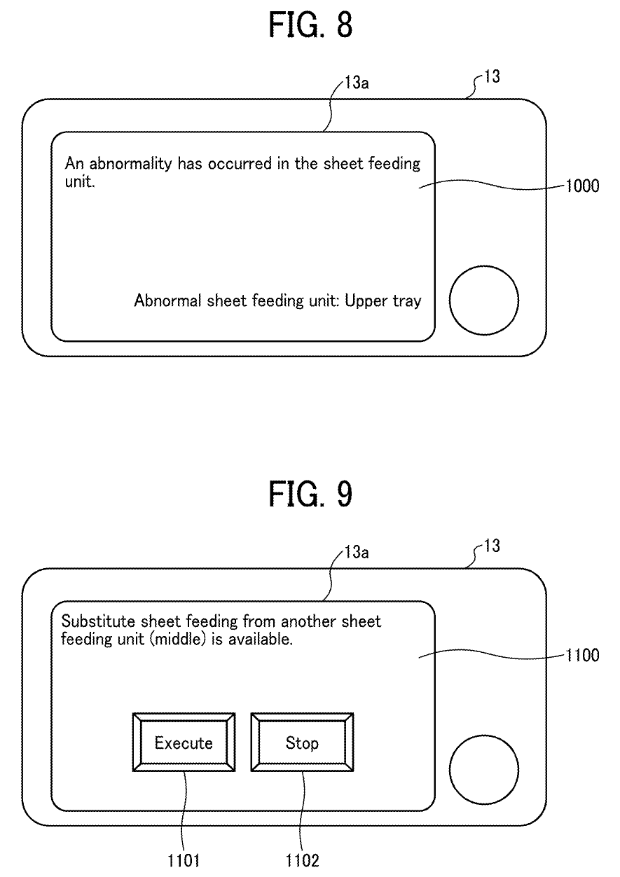

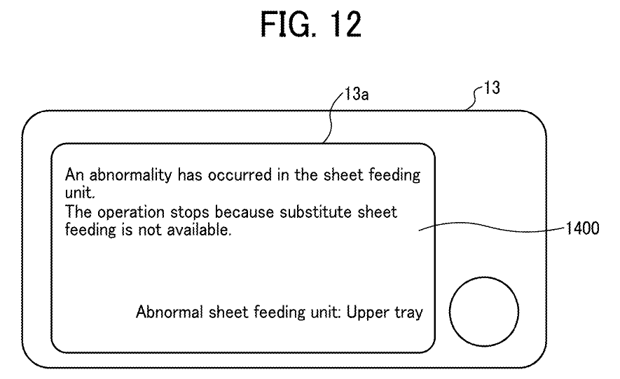

FIG. 7 is a flowchart of a sheet feeding process of the image forming apparatus 1. FIG. 8 is a diagram illustrating a blown fuse notification screen in the image forming apparatus 1. FIG. 9 is a diagram illustrating a substitute sheet feeding execution screen in the image forming apparatus 1. FIG. 10 is a diagram illustrating an image rotation execution screen in the image forming apparatus 1. FIG. 11 is a diagram illustrating a scaling execution screen in the image forming apparatus 1. FIG. 12 is a diagram illustrating an operation stop notification screen in the image forming apparatus 1. The procedure of the sheet feeding operation of the image forming apparatus 1 will be described with reference to FIGS. 7-12.

### Step S31

The main SoC 101 of the main control board 11 transmits a print instruction to each peripheral device control board 21. The process then proceeds to S32.

### Step S32

The main SoC 101 determines whether the fuse 272 is blown in each peripheral device control board 21. The determination may be made through the processing of steps S14 to S16 illustrated in FIG. 6 described above. Alternatively, when there is no response to a response request transmitted by the main SoC 101 to the sub SoC 201 of each peripheral device control board 21, it may be determined that the fuse 272 of the peripheral device control board 21 having no response is blown. The peripheral device control board 21 in which the fuse 272 is blown is referred to as an abnormal control board below. When the blown fuse 272 is absent (step S32: Yes), the process proceeds to step S41. When the blown fuse 272 is present (step S32: No), the process proceeds to step S33.

### Step S33

The main SoC 101 displays, on the liquid crystal panel 13a of the operation device 13 of the image forming apparatus 1, an indication that the fuse 272 is blown in the abnormal control board to make a notification to the user. FIG. 8 illustrates a blown fuse notification screen 1000 as an example of a screen displayed on the liquid crystal panel 13a for the notification. The blown fuse notification screen 1000, for example, identifies the sheet feeding unit 20 equipped with the peripheral device control board 21 in which the fuse 272 is blown. Clearly notifying the sheet feeding unit 20 having a failure in this manner makes it easier to deal with the failure and take an action until recovery. The process then proceeds to step S34.

### Step S34

The main SoC 101 determines whether substitute sheet feeding from the sheet feeding unit 20 other than the sheet feeding unit 20 equipped with the abnormal control board is available. It is determined whether substitute sheet feeding by the sheet feeding unit 20 other than the sheet feeding unit 20 equipped with the abnormal control board is available. Thus, the failure can be dealt with and an action until recovery can be taken. For example, when the abnormal control board is located upstream from (above) the peripheral device control board 21 of the sheet feeding unit 20 having a sheet to be fed and when the peripheral device control board 21 located downstream from (below) and adjacent to the abnormal control board can control the motor M of the abnormal control board in place of the abnormal control board, it is determined that substitute sheet feeding by the sheet feeding unit 20 (substitute sheet feeder) having the sheet to be fed is available. Even when the sheet feeding unit 20 having a sheet to be fed includes the abnormal control board and substitute sheet feeding by the sheet feeding unit 20 equipped with the peripheral device control board 21 located downstream from (below) the abnormal control board is available and when the peripheral device control board 21 adjacent to the abnormal control board located downstream (below) can control the motor M of the abnormal control board in place of the abnormal control board, it is determined that substitute sheet feeding is available.

In determination of whether substitute sheet feeding by the sheet feeding unit 20 other than the sheet feeding unit 20 equipped with the abnormal control board is available, when the orientation of a sheet loaded in the sheet feeding unit 20 does not match a printing direction of an image to be printed but printing can be performed by rotating the image to match the orientation of the sheet, it may be determined that substitute sheet feeding by the sheet feeding unit 20 is available. When the size of a sheet loaded in the sheet feeding unit 20 that performs substitute sheet feeding differs from the size of the sheet loaded in the sheet feeding unit 20 equipped with the abnormal control board but printing can be performed by scaling the image to be printed to match the size of the sheet loaded in the sheet feeding unit 20 that performs substitute sheet feeding, it may be determined that substitute sheet feeding by the sheet feeding unit 20 is available. The description is given below for the case of determining that substitute sheet feeding is available when the image is printable by rotating or scaling the image.

When a sheet is feedable from the sheet feeding unit 20 other than the sheet feeding unit 20 equipped with the abnormal control board (step S34: Yes), the process proceeds to step S35. When a sheet is not feedable (step S34: No), the process proceeds to step S43.

### Step S35

When the sheet feeding unit 20 having a sheet to be fed is equipped with the abnormal control board and substitute sheet feeding by the sheet feeding unit 20 equipped with the peripheral device control board 21 located downstream from (below) the abnormal control board is available, the main SoC 101 displays, on the liquid crystal panel 13a of the operation device 13, a screen that allows selection as to whether to execute substitute feeding. FIG. 9 illustrates a substitute sheet feeding execution screen 1100 as an example of the screen.

As illustrated in FIG. 9, the substitute sheet feeding execution screen 1100 includes an execute button 1101 and a stop button 1102. The execute button 1101 is a button for executing substitute sheet feeding by the sheet feeding unit 20 equipped with the peripheral device control board 21 located downstream from (below) the abnormal control board. The stop button 1102 is a button for stopping the printing operation without executing substitute sheet feeding.

When the execute button 1101 is pressed, the main SoC 101 determines that substitute sheet feeding is to be executed (step S35: Yes). The process proceeds to step S36. By contrast, when the stop button 1102 is pressed, the main SoC 101 determines that substitute sheet feeding is not to be executed (step S35: No), and ends the sheet feeding operation without executing substitute sheet feeding. The manner of determining whether to execute substitute sheet feeding is not limited to the user's selection on the substitute sheet feeding execution screen 1100 illustrated in FIG. 9. For example, the main SoC 101 may determine whether to execute substitute sheet feeding in accordance with a setting made in advance.

### Step S36

When it is determined that substitute sheet feeding is to be performed, the main SoC 101 determines whether the orientation of the sheet loaded in the sheet feeding unit 20 that performs substitute sheet feeding matches the printing direction of the image to be printed. When the orientation matches the printing direction (step S36: Yes), the process proceeds to step S38. When the orientation does not match the printing direction (step S36: No), the process proceeds to step S37.

### Step S37

The main SoC 101 displays, on the liquid crystal panel 13a of the operation device 13, a screen that allows selection as to whether to rotate the image to be printed to match the orientation of the sheet in the sheet feeding unit 20 that performs substitute sheet feeding. FIG. 10 illustrates an image rotation execution screen 1200 as an example of the screen.

As illustrated in FIG. 10, the image rotation execution screen 1200 includes a continue printing button 1201, a rotate image button 1202, and a stop button 1203. The continue printing button 1201 is a button for performing substitute sheet feeding without rotating the image to be printed. The rotate image button 1202 is a button for rotating the image to be printed to match the orientation of the sheet in the sheet feeding unit 20 that performs substitute sheet feeding. The stop button 1203 is a button for stopping the printing operation without performing substitute sheet feeding.

When the rotate image button 1202 is pressed (step S37: Yes), the main SoC 101 rotates the image to be printed to match the orientation of the sheet in the sheet feeding unit 20 that performs substitute sheet feeding. The process then proceeds to step S38. Accordingly, substitute sheet feeding can be performed without going to an image forming apparatus including a sheet feeding unit having the sheet orientation. This increases convenience when a failure occurs. By contrast, when the continue printing button 1201 or the stop button 1203 is pressed (step S37: No), the main SoC 101 does not rotate the image to be printed, and the process proceeds to step S40. The manner of determining whether to rotate the image or to perform substitute sheet feeding without rotating the image is not limited to the user's selection on the image rotation execution screen 1200 illustrated in FIG. 10. For example, the main SoC 101 may determine whether to rotate the image or to perform substitute sheet feeding without rotating the image in accordance with a setting made in advance.

### Step S38

The main SoC 101 determines whether the size of the sheet loaded in the sheet feeding unit 20 that performs substitute sheet feeding is the same as the size of a sheet loaded in the sheet feeding unit 20 equipped with the abnormal control board. When the sizes are the same (step S38: Yes), the process proceeds to step S41. When the sizes differ (step S38: No), the process proceeds to step S39.

### Step S39

The main SoC 101 displays, on the liquid crystal panel 13a of the operation device 13, a screen that allows selection as to whether to scale the image to be printed to match the size of the sheet loaded in the sheet feeding unit 20 that performs substitute sheet feeding. FIG. 11 illustrates a scaling execution screen 1300 as an example of the screen.

As illustrated in FIG. 11, the scaling execution screen 1300 includes a continue printing button 1301, a scaling button 1302, and a stop button 1303. The continue printing button 1301 is a button for performing substitute sheet feeding without scaling the image to be printed. The scaling button 1302 is a button for scaling the image to be printed to match the size of a sheet loaded in the sheet feeding unit 20 that performs substitute sheet feeding. The stop button 1303 is a button for stopping the printing operation without executing substitute sheet feeding.

When the scaling button 1302 is pressed (step S39: Yes), the main SoC 101 scales the image to be printed to match the size of a sheet loaded in the sheet feeding unit 20 that performs substitute sheet feeding. The process then proceeds to step S41. Accordingly, substitute sheet feeding can be performed without going to an image forming apparatus including a sheet feeding unit having sheets of the same size. This increases convenience when a failure occurs. By contrast, when the continue printing button 1301 or the stop button 1303 is pressed (step S39: No), the main SoC 101 does not scale the image to be printed, and the process proceeds to step S40. The manner of determining whether to scale the image or to perform substitute sheet feeding without scaling the image is not limited to the user's selection on the scaling execution screen 1300 illustrated in FIG. 11. For example, the main SoC 101 may determine whether to scale the image or to perform substitute sheet feeding without scaling the image in accordance with a setting made in advance.

### Step S40

When the sheet feeding unit 20 performs substitute sheet feeding without processing the image, that is, when the continue printing button 1201 is pressed in step S37 or the continue printing button 1301 is pressed in step S39 (step S40: Yes), the process proceeds to step S41. By contrast, when substitute sheet feeding is not performed, that is, when the stop button 1203 is pressed in step S37 or the stop button 1303 is pressed in step S39 (step S40: No), the sheet feeding operation ends without performing substitute sheet feeding.

### Step S41

When an abnormal control board is absent, the sheet feeding unit 20 having a sheet to be fed executes sheet feeding. When the sheet feeding unit 20 having a sheet to be fed is equipped with the abnormal control board and substitute sheet feeding is performed by the sheet feeding unit 20 equipped with the peripheral device control board 21 located downstream from (below) the abnormal control board, the sheet feeding unit 20 performs sheet feeding. In this case, the peripheral device control board 21 of the sheet feeding unit 20 controls driving of the motor M of the abnormal control board in place of the abnormal control board. This enables sheet feeding via the sheet feeding unit 20 equipped with the abnormal control board. The process then proceeds to step S42.

### Step S42

When a print job has ended (step S42: Yes), the image forming apparatus 1 ends the sheet feeding operation. When the print job has not ended (step S42: No), the process returns to step S41 to continue sheet feeding.

### Step S43

The main SoC 101 displays, on the liquid crystal panel 13a of the operation device 13, an operation stop notification screen 1400 as illustrated in FIG. 12 for notifying the user that a sheet is not feedable from the sheet feeding unit 20 other than the sheet feeding unit 20 equipped with the abnormal control board. The image forming apparatus 1 then ends the sheet feeding operation.

In a system including a plurality of sheet feeding units, when conveying power supplied to the sheet feeding device is simultaneously turned on or off to switch between a supply stop state and a supply state of the sheet feeding devices, conveying operations of the sheet feeding devices are simultaneously switched. With this method, when an abnormality occurs in one of the sheet feeding units arranged in multiple stages, printing cannot be continued by performing substitute sheet feeding from another sheet feeding unit in place of the sheet feeding unit in which the abnormality has occurred.

In view of the above, in the image forming apparatus 1, the apparatus body 10 outputs a print instruction. The sheet feeding unit 20_1 is supplied with power from the apparatus body 10 and feeds a sheet in response to the print instruction. The sheet feeding unit 20_2 is supplied with power from the sheet feeding unit 20_1 and feeds a sheet in response to the print instruction. The motor M_1 is included in the sheet feeding unit 20_1 and performs a sheet conveying operation. The fuse 272_1 cuts off power supply from the apparatus body 10 to the sheet feeding unit 20_1 when an overcurrent occurs in the sheet feeding unit 20_1. The selector 283_1 switches from a first drive path for the motor M_1 provided by the sheet feeding unit 20_1 (first sheet feeder) to a second drive path for the motor M_1 provided by the sheet feeding unit 20_2 (second sheet feeder) when the power supply is cut off by the fuse 272_1. In other words, the selector 283_1 serving as the (first) switch switches power supply to the motor M_1 (conveyance motor) from the first drive path to the second drive path when the power from the apparatus body to the first sheet feeder is cut off. The drive path is formed by the peripheral device control board 21 (the sub SoC 201), the drive circuit 281 (282), the selector 283, the power supply line, and drive signal line.

Accordingly, among the sheet feeding units 20 connected to each other by daisy-chain connection, even when power supply is cut off for any sheet feeding unit at an intermediate position, a sheet is feedable from a sheet feeding unit at a subsequent position.

Aspects of the present disclosure are as follows.

According to Aspect 1, a sheet feeding system includes an apparatus body, a first sheet feeder, a second sheet feeder, a conveyance motor, a cutoff circuit, and a first switch. The apparatus body outputs a print instruction. The first sheet feeder is supplied with power from the apparatus body and feeds a sheet in response to the print instruction. The second sheet feeder is supplied with power from the first sheet feeder and feeds a sheet in response to the print instruction. The conveyance motor is included in the first sheet feeder and performs a sheet conveying operation. The cutoff circuit cuts off power supply from the apparatus body to the first sheet feeder when an overcurrent occurs in the first sheet feeder. The first switch switches a path of driving the conveyance motor from the first sheet feeder to a path of driving the conveyance motor from the second sheet feeder when the power supply is cut off by the cutoff circuit.

According to Aspect 2, the sheet feeding system of Aspect 1 further includes a first control apparatus, a second control apparatus, a third control apparatus, a first drive circuit, and a second drive circuit. The first control apparatus is included in the apparatus body and controls an operation of the apparatus body. The second control apparatus is included in the first sheet feeder, controls an operation of the first sheet feeder, and communicates with the first control apparatus. The third control apparatus is included in the second sheet feeder to control an operation of the second sheet feeder and communicate with the second control apparatus. The first drive circuit is included in the first sheet feeder and drives the conveyance motor in accordance with control by the first sheet-feeding circuitry. The second drive circuit is included in the second sheet feeder and is controlled by the third control apparatus. The first switch switches a path of supplying a drive current from the first drive circuit to the conveyance motor to a path of supplying the drive current from the second drive circuit to the conveyance motor when the power supply is cut off by the cutoff circuit.

According to Aspect 3, the sheet feeding system of Aspect 1 or 2 further includes an indicator. The indicator indicates the cutoff of the power supply when the power supply is cut off by the cutoff circuit.

According to Aspect 4, in the sheet feeding system of Aspect 2, the first control apparatus determines whether substitute sheet feeding by a substitute sheet feeding unit other than the first sheet feeder is available when the power supply is cut off by the cutoff circuit.

According to Aspect 5, in the sheet feeding system of Aspect 4, when the first control apparatus determines that substitute sheet feeding by the substitute sheet feeding unit other than the first sheet feeder is available and an orientation of a sheet loaded in the substitute sheet feeding unit does not match a printing direction of an image to be printed, the first control apparatus rotates the image to match the orientation.

According to Aspect 6, the sheet feeding system of Aspect 4 further includes an input device. The input device receives an operation. When the first control apparatus determines that substitute sheet feeding by the substitute sheet feeding unit other than the first sheet feeder is available and the orientation of the sheet loaded in the substitute sheet feeding unit does not match the printing direction of the image to be printed, the first control apparatus selects whether to rotate the image to match the orientation, in accordance with the operation received by the input device.

According to Aspect 7, in the sheet feeding system of Aspect 4, when the first control apparatus determines that substitute sheet feeding by the substitute sheet feeding unit other than the first sheet feeder is available and a sheet loaded in the substitute sheet feeding unit has a size different from a size of a sheet loaded in the first sheet feeder, the first control apparatus scales the image to be printed to match the size of the sheet loaded in the substitute sheet feeding unit that performs substitute sheet feeding.

According to Aspect 8, the sheet feeding system of Aspect 7 further includes an input device. The input device receives an operation. When the first control apparatus determines that substitute sheet feeding by the substitute sheet feeding unit other than the first sheet feeder is available and the sheet loaded in the substitute sheet feeding unit has a size different from the size of the sheet loaded in the first sheet feeder, the first control apparatus selects, in accordance with the operation received by the input device, whether to scale the image to be printed to match the size of the sheet loaded in the substitute sheet feeding unit that performs substitute sheet feeding.

According to Aspect 9, the sheet feeding system of Aspect 2 further includes a second switch. The second switch is included in the first sheet feeder and switches the communication path for the first control apparatus between a first communication path to communicate with the second control apparatus and a second communication path to communicate with the third control apparatus. The second switch switches the communication path for the first control apparatus to the second communication path so that the first control apparatus communicates with the third control apparatus when the power supply is cut off by the cutoff circuit.

According to Aspect 10, a sheet feeding method for a sheet feeding system, the sheet feeding system including an apparatus body to output a print instruction, a first sheet feeder to be supplied with power from the apparatus body and to feed a sheet in accordance with the print instruction, a second sheet feeder to be supplied with power from the first sheet feeder and to feed a sheet in response to the print instruction, and a conveyance motor included in the first sheet feeder to perform a sheet conveying operation, the sheet feeding method includes: cutting off power supply from the apparatus body to the first sheet feeder when an overcurrent occurs in the first sheet feeder; and switching a path of driving the conveyance motor from the first sheet feeder to a path of driving the conveyance motor from the second sheet feeder when the power supply is cut off in the cutting off of the power supply.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disc (DVD), and/or the memory of an FPGA or ASIC.

1. A sheet feeding system comprising:
an apparatus body including apparatus circuitry to output a print instruction;
a first sheet feeder to selectively perform sheet feeding with power supply from the apparatus body in response to the print instruction;
a second sheet feeder to selectively perform sheet feeding with power supply from the first sheet feeder in response to the print instruction;
a conveyance motor to generate a sheet feeding force, the conveyance motor included in the first sheet feeder;
a first drive path in which power from the apparatus body is supplied to the conveyance motor without passing through the second sheet feeder;
a second drive path in which the power from the apparatus body is supplied to the conveyance motor via the second sheet feeder;
a cutoff circuit configured to cut off the power supply through the first drive path when an overcurrent occurs in the first sheet feeder; and
a switch to switch the power supply from the apparatus body to the conveyance motor from the first drive path to the second drive path when the power supply through the first drive path is cut off by the cutoff circuit.

2. The sheet feeding system according to claim 1, wherein
the apparatus circuitry is configured to control the apparatus body;
the first sheet feeder includes:
first sheet-feeding circuitry configured to control the first sheet feeder and communicate with the apparatus circuitry; and
a first drive circuit configured to drive the conveyance motor under control of the first sheet-feeding circuitry;
the second sheet feeder includes:
second sheet-feeding circuitry configured to control the second sheet feeder and communicate with the first sheet-feeding circuitry; and
a second drive circuit controlled by the second sheet-feeding circuitry, and
when the power supply through the first drive path is cut off by the cutoff circuit, the switch switches from a first path in which the conveyance motor is supplied with a drive current from the first drive circuit to a second path in which the conveyance motor is supplied with a drive current from the second drive circuit.

3. The sheet feeding system according to claim 1, further comprising an indicator to indicate a power cutoff when the power supply through the first drive path is cut off by the cutoff circuit.

4. The sheet feeding system according to claim 2,
wherein the apparatus circuitry is configured to determine whether substitute sheet feeding by a substitute sheet feeder other than the first sheet feeder is available when the power supply through the first drive path is cut off by the cutoff circuit.

5. The sheet feeding system according to claim 4,
wherein, when the apparatus circuitry determines that the substitute sheet feeding is available and an orientation of a sheet loaded in the substitute sheet feeder does not match a printing direction of an image to be printed, the apparatus circuitry is configured to rotate the image to match the orientation of the sheet.

6. The sheet feeding system according to claim 5, further comprising an input device to receive an operation,
wherein, when the apparatus circuitry determines that the substitute sheet feeding is available and the orientation of the sheet loaded in the substitute sheet feeder does not match the printing direction of the image to be printed, the apparatus circuitry is configured to select whether to rotate the image to match the orientation according to the operation received by the input device.

7. The sheet feeding system according to claim 4,
wherein, when the apparatus circuitry determines that the substitute sheet feeding is available and a sheet loaded in the substitute sheet feeder is different in size from a sheet loaded in the first sheet feeder, the apparatus circuitry is configured to scale the image to be printed to match a size of the sheet loaded in the substitute sheet feeder.

8. The sheet feeding system according to claim 7, further comprising an input device to receive an operation,
wherein, when the apparatus circuitry determines that substitute sheet feeding is available and the sheet loaded in the substitute sheet feeder is different in size from the sheet loaded in the first sheet feeder, the apparatus circuitry is configured to select, according to the operation received by the input device, whether to scale the image to be printed to match the size of the sheet loaded in the substitute sheet feeder.

9. The sheet feeding system according to claim 2, wherein
the first sheet feeder further includes another switch to switch a communication path for the apparatus circuitry between a first communication path in which the apparatus circuitry communicates with the first sheet-feeding circuitry and a second communication path in which the apparatus circuitry communicates with the second sheet-feeding circuitry, and
when the power supply through the first drive path is cut off by the cutoff circuit, said another switch switches the communication path from the first communication path to the second communication path.

10. A sheet feeding method for a sheet feeding system including an apparatus body, a first sheet feeder including a conveyance motor, a second sheet feeder, a first drive path in which power from the apparatus body is supplied to the conveyance motor without passing through the second sheet feeder, and a second drive path in which the power from the apparatus body is supplied to the conveyance motor via the second sheet feeder, the method comprising:
cutting off, with a cutoff circuit, power supply through the first drive path when an overcurrent occurs in the first sheet feeder; and
switching the power supply from the apparatus body to the conveyance motor from the first drive path to the second drive path when the power supply through the first drive path is cut off by the cutoff circuit.
